(19) United States
(12) Patent Application Publication
(10) Pub. No.: US 2018/0026498 A1
(43) Pub. Date: Jan. 25, 2018

(54) SHAFT GROUNDING SYSTEM

(71) Applicant: SIEMENS ENERGY, INC., Orlando, FL (US)

(72) Inventor: Edward David Thompson, Casselberry, FL (US)

(21) Appl. No.: 15/216,089

(22) Filed: Jul. 21, 2016

(51) Int. Cl. H02K 11/40; H01R 39/38; H02K 11/26

(52) U.S. Cl. CPC H02K 11/40; H02K 11/26; H01R 39/38

(57) ABSTRACT

A shaft grounding system and a method for ground a shaft are presented. The shaft grounding system includes a shaft grounding assembly. An insulation layer may be arranged in the shaft grounding assembly that splits the shaft grounding assembly to a first part and a second part. The first part includes a measurement circuit having high impedance such that virtually all current of the shaft travels through the second part. The shaft grounding system with the split shaft grounding assembly provides an accurate shaft voltage measurement due to the high impedance of the measuring circuit. The shaft grounding system presented is very low cost, installs using the existing shaft ground mounting components, and allows condition based maintenance of the shaft grounding system.

### FIELD OF THE INVENTION

This invention relates generally to a shaft grounding system and a method for grounding a shaft.

### DESCRIPTION OF THE RELATED ART

An electrical power generator, for example, a turbine generator, may convert mechanical power into electrical currents. Electrical potentials may be built up on the turbine generator or motor shaft during the power generator operation. Grounding the electrical potentials that build up on the turbine generator or motor shafts is crucial to avoid major damage to bearings and resulting consequential damage. Shaft grounding systems may be used to serve such a purpose.

Shaft grounding systems may use brush assemblies such as carbon brushes or copper braids to ground the rotating shaft. A semiconducting film layer due to dirt or oil may be formed between the brush assemblies and the rotating shaft. Such grounding systems cannot compensate for this layer, or warn an operator when maintenance is required to clean the brush assemblies and the rotating shaft.

A solution for solving such an issue may be to rely on proper maintenance scheduling to do maintenance on the shaft ground systems at predetermined intervals. This solution may address glazing or dirt buildup. This solution, however, may not address other equipment problems that may cause rapid failure. Furthermore, if the maintenance interval is misjudged or missed, there may be an opportunity for the shaft ground systems to deteriorate to levels that may endanger the turbine, the generator, or the motor. There is also a potential for performing maintenance more often than required which adds unnecessary cost to plant operation.

Other solutions for solving such an issue may be to install active shaft grounding system or on-line monitoring system. Such system, however, may require additional dedicated brush assemblies and measurement points. The cost of such system is high. The installation of such system is not easy.

### SUMMARY OF THE INVENTION

Briefly described, aspects of the present invention relate to a shaft grounding system and method for grounding a shaft, specifically a shaft grounding system and method for grounding a turbine generator shaft.

According to an aspect, a shaft grounding apparatus is presented. The shaft grounding apparatus comprises a shaft grounding assembly attached to a shaft. The shaft grounding apparatus comprises an insulation layer arranged in the shaft grounding assembly that splits the shaft grounding assembly to a first part and a second part. The shaft grounding apparatus comprises a first cable connected to the first part. The shaft grounding apparatus comprises a first circuit connected to the first cable that is configured to measure a signal of the first part for monitoring an operation of the shaft grounding assembly. The first circuit may have an impedance such that current of the shaft travels through the second part. The shaft grounding apparatus comprises a second cable connected to the second part that is configured to carry the current of the shaft to ground.

According to an aspect, a shaft grounding system is presented. The shaft grounding system comprises a shaft grounding assembly attached to a shaft. The shaft grounding system comprises an insulation layer arranged in the shaft grounding assembly that splits the shaft grounding assembly to a first part and a second part. The shaft grounding system comprises a first cable connected to the first part. The shaft grounding system comprises a first circuit connected to the first cable that is configured to measure a signal of the first part. The first circuit may have an impedance such that current of the shaft travels through the second part. The shaft grounding system comprises a second cable connected to the second part. The shaft grounding system comprises a second circuit connected to the second cable that is configured to measure a signal of the second part. The shaft grounding system comprises a panel connected to the first circuit and the second circuit that is configured to monitor an operation of the shaft grounding assembly based on the measured signals of the first part and the second part.

According to an aspect, a method for grounding a shaft is presented. The method comprises measuring a signal of a first part of a shaft grounding assembly attached to the shaft by a first circuit. The shaft grounding assembly comprises an insulation layer that splits the shaft grounding assembly to the first part and a second part. The first circuit may be connected to the first part via a first cable. The first circuit may have an impedance such that current of the shaft travels through the second part. The method comprises carrying the current of the shaft to ground via a second cable connected to the second part.

Various aspects and embodiments of the application as described above and hereinafter may not only be used in the combinations explicitly described, but also in other combinations. Modifications will occur to the skilled person upon reading and understanding of the description.

### BRIEF DESCRIPTION OF THE DRAWINGS

Exemplary embodiments of the application are explained in further detail with respect to the accompanying drawings. In the drawings:

FIG. 1 illustrates a schematic diagram of a shaft grounding apparatus according to an embodiment, wherein the shaft grounding apparatus comprises a brush shaft grounding assembly;

FIG. 2 illustrates a schematic diagram of a shaft grounding apparatus according to an embodiment, wherein the shaft grounding apparatus comprises a braid shaft grounding assembly;

FIG. 3 illustrates a schematic diagram of a brush shaft grounding assembly according to an embodiment;

FIG. 4 illustrates a schematic diagram of a braid shaft grounding assembly according to an embodiment;

FIG. 5 illustrates a schematic diagram of a shaft grounding system according to an embodiment, wherein the shaft grounding system comprises a brush shaft grounding assembly; and

FIG. 6 illustrates a schematic diagram of a shaft grounding system according to an embodiment, wherein the shaft grounding system comprises a braid shaft grounding assembly.

To facilitate understanding, identical reference numerals have been used, where possible, to designate identical elements that are common to the figures.

### DETAILED DESCRIPTION OF INVENTION

A detailed description related to aspects of the present invention is described hereafter with respect to the accompanying figures.

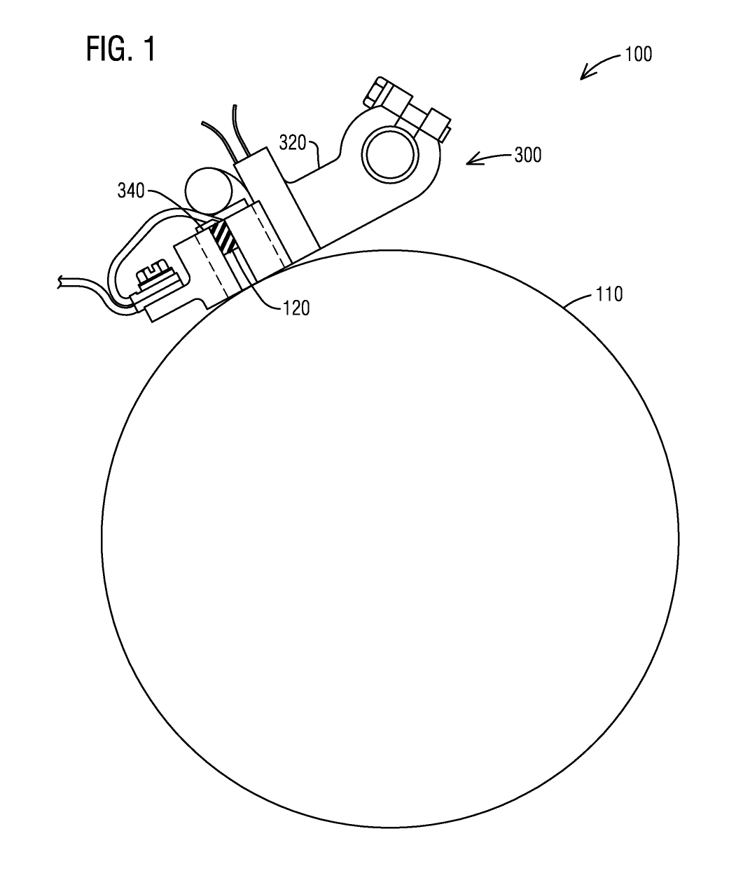

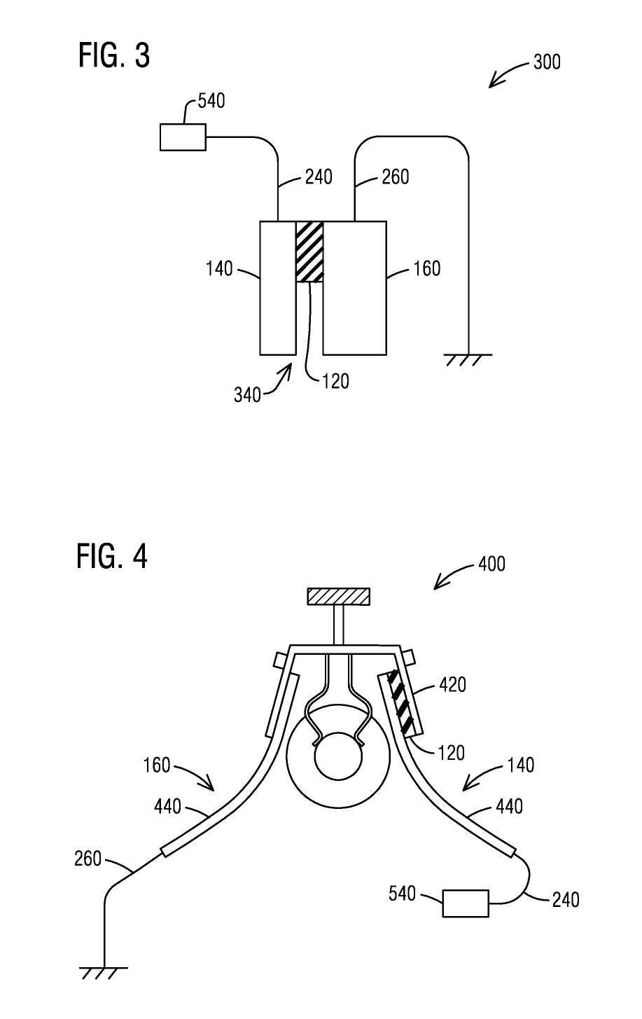

FIG. 1 illustrates a shaft grounding apparatus 100 according to an embodiment. The shaft grounding apparatus 100 comprises a shaft grounding assembly 300. In the exemplary illustrated embodiment of FIG. 1, the shaft grounding assembly 100 may include a brush shaft grounding assembly 300. The brush shaft grounding assembly 300 may include a brush holder 320 that holds a brush 340. The brush 340 may contact a shaft 110. The brush 340 may carry a current of the shaft 110 to ground. The shaft grounding apparatus 100 may include an insulation layer 120. The insulation layer 120 may be designed within the brush 340. The insulation layer 120 may split the shaft grounding assembly 300 to two parts. A detail description of the split brush shaft grounding assembly 300 is illustrated in FIG. 3.

In the exemplary illustrated embodiment of FIG. 1, the brush shaft grounding assembly 300 includes one brush 340 contacting a shaft 110. According to an embodiment, a brush shaft grounding assembly 300 may include a plurality of brushes 340 contacting a shaft 110. An insulation layer 120 may be designed within at least one of the brushes 340.

According to an embodiment, a brush shaft grounding assembly 300 may include a carbon brush shaft assembly 300. The carbon brush shaft assembly 300 may include a carbon brush 340 that contacts a shaft 110. The shaft 110 may include a turbine generator shaft or a motor shaft.

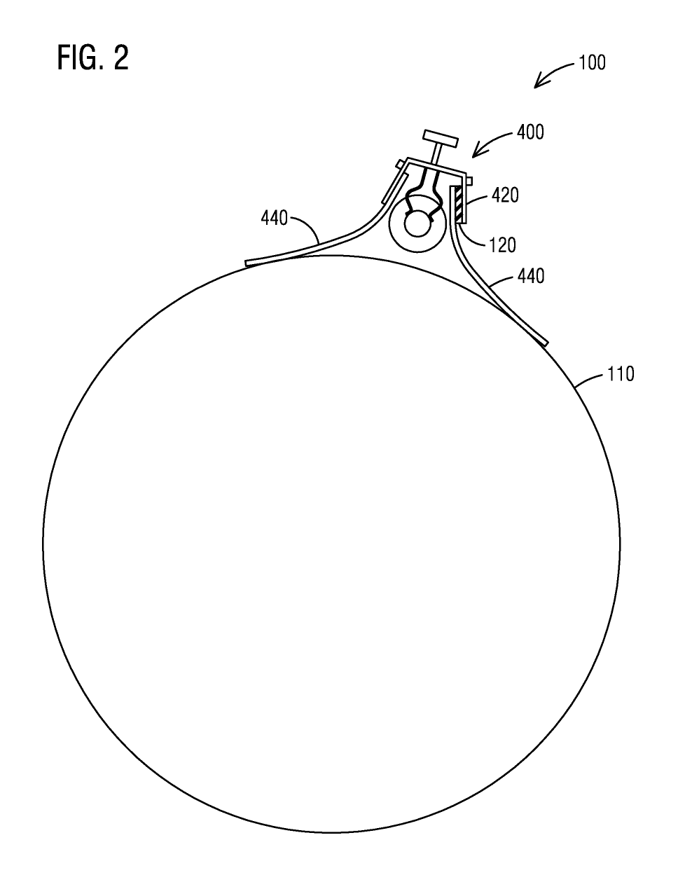

FIG. 2 illustrates a shaft grounding apparatus 100 according to an embodiment. Note in this illustration the assembly clip is not attached to the mounting pin. The shaft grounding apparatus 100 comprises a shaft grounding assembly 400. In the exemplary illustrated embodiment of FIG. 2, the shaft grounding assembly 400 may include a braid shaft grounding assembly 400. The braid shaft grounding assembly 400 may include a braid support 420 that supports a plurality of braids 440. The braids 440 may contact a shaft 110. The braids 440 may carry a current of the shaft 110 to ground. The shaft grounding apparatus 100 may include an insulation layer 120. The insulation layer 120 may be designed between the braid support 420 and one of the braids 440. The insulation layer 120 may split the braid shaft grounding assembly 400 to two parts. A detail description of the split braid shaft grounding assembly 400 is illustrated in FIG. 4.

In the exemplary illustrated embodiment of FIG. 2, the braid shaft grounding assembly 400 includes a braid support 420 that supports two braids 440 contacting a shaft 110. According to an embodiment, a braid shaft grounding assembly 400 may include a braid support 420 that supports more than two braids 440 contacting the shaft 110. An insulation layer 120 may be designed between the braid support 420 and at least one of the braids 440.

According to an embodiment, a braid shaft grounding assembly 100 may include a copper braid shaft assembly 400. The copper braid shaft assembly 400 may include a plurality of copper braids 440 contacting a shaft 110.

FIG. 3 illustrates a schematic diagram of a brush shaft grounding assembly 300 according to an embodiment. The brush shaft grounding assembly 300 may include a brush 340 contacting a shaft 110 (not shown in FIG. 3). An insulation layer 120 may be designed within the brush 340. The insulation layer 120 may split the brush shaft grounding assembly 300 to two parts, a first part 140 and a second part 160. A first cable 240 may be connected to the first part 140. A first circuit 540 may be connected to the first cable 240. The first circuit 540 may measure a signal of the first part 140. According to an embodiment, the first circuit 540 may include a high impedance such that virtually all current of the shaft 110 may travel through the second part 160. A second cable 260 may be connected to the second part 160. The second cable 260 may carry virtually all the current of the shaft 110 to ground. According to an embodiment, a signal of the first part 140 that is measured by the first circuit 540 may include a voltage of the first part 140 or a current traveling through the first part 140.

FIG. 4 illustrates a schematic diagram of a braid shaft grounding assembly 400 according to an embodiment. The braid shaft grounding assembly 400 may include a plurality of braids 440 contacting a shaft 110 (not shown in FIG. 4). The braid shaft grounding assembly 400 may include a braid support 420 that supports the braids 440. In the exemplary illustrated embodiment of FIG. 4, the braid support 420 may be a V shape support 420. An insulation layer 120 may be designed between the braid support 420 and one of the braids 440. The insulation layer 120 may split the braid shaft grounding assembly 400 to two parts, a first part 140 and a second part 160. A first cable 240 may be connected to the first part 140. A first circuit 540 may be connected to the first cable 240. The first circuit 540 may measure a signal of the first part 140. According to an embodiment, the first circuit 540 may include a high impedance such that virtually all current of the shaft 110 may travel through the second part 160. A second cable 260 may be connected to the second part 160. The second cable 260 may carry virtually all the current of the shaft 110 to ground. According to an embodiment, a signal of the first part 140 that is measured by the first circuit 540 may include a voltage of the first part 140 or a current traveling through the first part 140.

A semiconducting film layer due to dirt or oil may be formed at times between a shaft 110 and a brush 340 of a brush shaft grounding assembly 300 or a braid 440 of a braid shaft grounding assembly 400. A resistance of the film layer, for example, may be about 20 Ohms. A resistance of a first cable 240, for example, may be about 1 Ohm. According to an embodiment, an impedance of the first circuit 540 may be high enough such that only a very small current of the shaft 110 may travel through the first part 140. According to an embodiment, an impedance of the first circuit 540 may be at least in an order of thousand Ohms, or may be at least in an order of mega Ohms. For example, an impedance of the first circuit 540 may be about 2 mega Ohms. A high impedance of the first circuit 540 may result in that virtually all current of the shaft 110 may travel through the second part 160. A voltage drop across the film layer between the shaft 110 and the brush 340 or the braid 440, the brush 340 or the braid 440, and the first cable 240 may be effectively zero, for example, may be in an order of a few microvolts, or may be in an order of a few millivolts. The first circuit 540 may measure an accurate signal of the shaft 110. Virtually all current of the shaft 110 may be carried to ground via a second cable 260.

According to an embodiment, a first circuit 540 may generate an alert signal based on the measured signal of the first part 140. An alert signal may be generated if the measured signal of the first part 140 is not within a predetermined range. The range may be predetermined to adapt a condition of a generator or a condition of a shaft 110. According to an embodiment, a range for generating an alert signal may be in an order of a fraction of a volt, or in an order of a volt. An alert signal may indicate that a shaft 110 may be not operating at an optimum grounding potential that may result in major damage to bearings or component malfunction. Maintenance of a shaft grounding apparatus 100 may be required to avoid such damages. The maintenance may include cleaning the shaft 110 to remove a film layer that builds up between the shaft 100 and the brush shaft grounding assembly 300 or the braid shaft grounding assembly 400. The maintenance may include replacing a brush 340 of the shaft grounding assembly 300 or braids 440 of the braid shaft grounding assembly 400.

According to an embodiment, a first circuit 540 may include a volt meter or a current meter. The volt meter or the current meter may include a digital display.

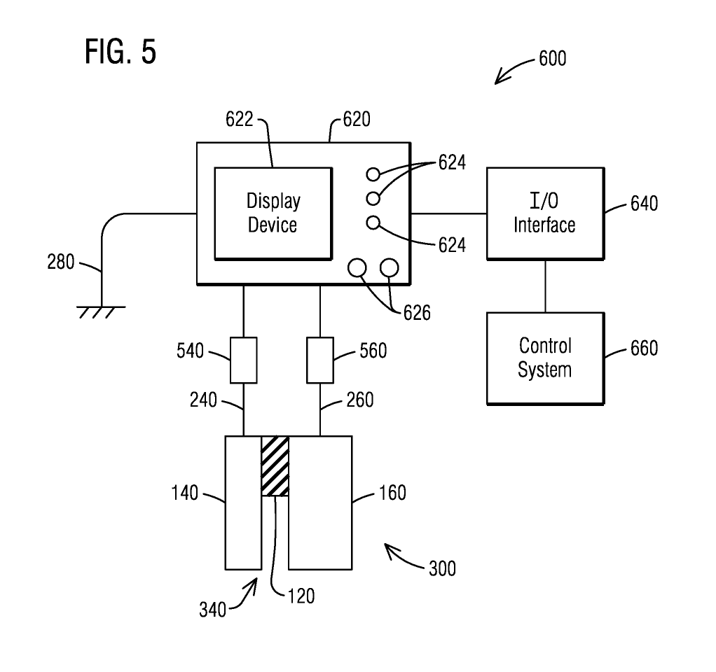

FIG. 5 illustrates a schematic diagram of a shaft grounding system 600 according to an embodiment. The shaft grounding system 600 may include a brush shaft grounding assembly 300. The embodiment of the brush shaft grounding assembly 300 may correspond to the embodiment illustrated in FIG. 3. Corresponding parts of the brush shaft grounding assembly 300 are correspondingly numbered, but are not described again with reference to FIG. 5.

In the exemplary embodiment illustrated of FIG. 5, a first circuit 540 may be connected to a first cable 240. A second circuit 560 may be connected to a second cable 260. A panel 620 may be connected to the first circuit 540 and the second circuit 560. A ground cable 280 may be connected to the panel 620. The ground cable 280 may be attached to a ground point. The ground point should be cleaned free of oil, rust, dirt, paint, or other contaminants before attaching the ground cable 280. The first circuit 540 may measure a signal of the first part 140. The second circuit 560 may measure a signal of the second part 160. According to an embodiment, the first circuit 540 may include a high impedance such that virtually all current of the shaft 110 may travel through the second part 160.

According to an embodiment, the first circuit 540 or the second circuit 560 may include a volt meter or a current meter. The volt meter or the current meter may include a digital display. A signal of the first part 140 that is measured by the first circuit 540 may include a voltage of the first part 140 or a current traveling through the first part 140. A signal of the second part 160 that is measured by the second circuit 560 may include a voltage of the second part 160 or a current traveling through the second part 160.

According to an embodiment, the panel 620 may be a circuit board that comprises a plurality of electronic devices. A size of the panel 620 may be small, such as in a hand held size chassis. The panel 620 may be made from a material, such as plastic.

The panel 620 may include a display device 622 that may display the measured signals of the first part 140 or the second part 160, or a difference between the measured signals of the first part 140 and the second part 160. The display device 622 may include a digital display device, such as a LCD (liquid crystal display).

The panel 620 may include an alert device 624 that may generate an alert signal based on the measured signals of the first part 140 or the second part 160, or a difference between the measured signals of the first part 140 and the second part 160. An alert signal may be generated if the measured signals of the first part 140 or the second part 160, or a difference between the measured signals of the first part 140 and the second part 160 is not within a predetermined range. The range may be predetermined to adapt a condition of a generator or a condition of a shaft 110. According to an embodiment, a range for generating an alert signal may be in an order of a fraction of a volt, or in an order of a volt. An alert signal may indicate that a shaft 110 may be not operating at an optimum grounding potential that may result in major damage to bearings or component malfunction. Maintenance of a shaft grounding apparatus 100 may be required to avoid such damages. The maintenance may include cleaning the shaft 110 to remove a film layer that builds up between the shaft 100 and the brush shaft grounding assembly 300 or the braid shaft grounding assembly 400. The maintenance may include replacing a brush 340 of the shaft grounding assembly 300 or braids 440 of the braid shaft grounding assembly 400. The alert device 624 may include a LED (light-emitting diode), or an audio alert device.

The panel 620 may include an input device 626. The input device 626 may be used by a user to input a predetermined range of the measured signals of the first part 140 or the second part 160, or a difference between the measured signals of the first part 140 and the second part 160. The input device 626 may be used to setup an alert sensitivity, such as, low, medium, or high alert. For example, a low sensitivity alert may be set 4 times of a predetermined range. A medium sensitivity alert may be set 3 times of a predetermined range. A high sensitivity alert may be set 2 times of a predetermined range. The input device 626 may include a setup button.

According to an embodiment, the shaft grounding system 600 may include an I/O (input/output) interface 640. The I/O interface 640 may be connected between the panel 620 and a control system 660. The control system 660 may be a central control system that controls an operation of a turbine generator at a power plant site. The I/O interface 640 may convert a signal from an analog signal to a digital signal or vise versa. The I/O interface 640 may transfer a signal between the panel 620 and the control system 660. The control system 660 may display a signal from the panel 620. The control system 660 may store a history of the signal from the panel 620. The control system 660 may send a command to the panel 620.

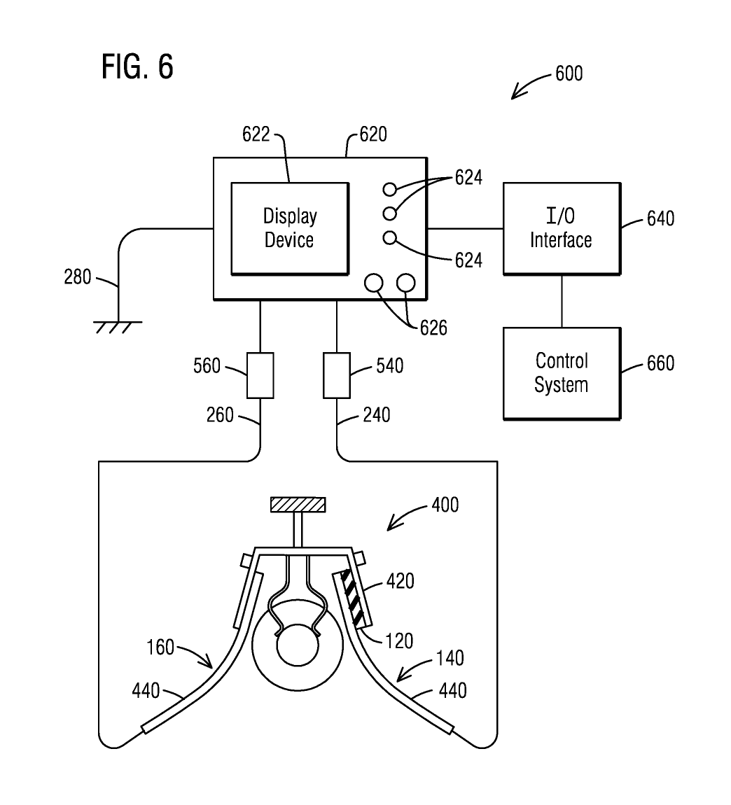

FIG. 6 illustrates a schematic diagram of a shaft grounding system 600 according to an embodiment. The shaft grounding system 600 may include a braid shaft grounding assembly 400. The embodiment of the braid shaft grounding assembly 400 may correspond to the embodiment illustrated in FIG. 4. The embodiment of FIG. 6 otherwise corresponds to the embodiment of FIG. 5. Corresponding parts of FIG. 6 are correspondingly numbered, but are not described again with reference to FIG. 6.

According to an embodiment, the illustrated shaft grounding apparatus 100 and shaft grounding system 600 may provide a continuous shaft grounding monitor utilizing a split shaft grounding assembly. The split shaft grounding assembly may be installed in a standard shaft grounding system to fit in an existing holder, or an existing rigging, or an existing mounting stud. The split shaft grounding assembly does not require an additional brush or measurement point. An installation of the split shaft grounding assembly is safe and easy. It may be installed during normal maintenance. The disclosed invention enables truly condition based maintenance for shaft grounding.

According to an embodiment, the illustrated shaft grounding apparatus 100 and shaft grounding system 600 with a split shaft grounding assembly provides an accurate shaft voltage measurement due to the high impedance of a measuring circuit. The illustrated shaft grounding apparatus 100 and shaft grounding system 600 require minimal electronics. The electronics may be a low cost circuit board. The electronics require a minimal power supply. The power may be supplied by a battery, or by a shaft voltage itself, or by a wetting voltage from a control system. The disclosed invention allows a continuous shaft ground monitoring with low cost. A continuous shaft ground monitoring provides warning of potential failures before major damage occurs to bearings.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

### LIST OF REFERENCES

100 Shaft Grounding Apparatus
110 Shaft
120 Insulation Layer
140 First Part of Shaft Grounding Assembly
160 Second Part of Shaft Grounding Assembly
240 First Cable
260 Second Cable
280 Ground Cable
300 Brush Shaft Grounding Assembly
320 Brush Holder
340 Brush
400 Braid Shaft Grounding Assembly
420 Support of Braid Shaft Grounding Assembly
440 Braid of Braid Shaft Grounding Assembly
540 First Circuit
560 Second Circuit
600 Shaft Grounding System
620 Panel
622 Display Device
624 Alert Device
626 Input Device
640 I/O Interface
660 Control System

What is claimed is:

1. A shaft grounding apparatus comprising:
a shaft grounding assembly configured to contact a shaft;
an insulation layer arranged in the shaft grounding assembly that splits the shaft grounding assembly to a first part and a second part;
a first cable connected to the first part;
a first circuit connected to the first cable that is configured to measure a signal of the first part for monitoring an operation of the shaft grounding assembly, wherein the first circuit has an impedance such that current of the shaft travels through the second part; and
a second cable connected to the second part that is configured to carry the current of the shaft to ground.

2. The apparatus as claimed in claim 1, wherein the measured signal comprises a voltage of the first part or a current traveling through the first part.

3. The apparatus as claimed in claim 1, wherein an alert signal is generated if the measured signal of the first part is not within a predetermined range.

4. The apparatus as claimed in claim 1, wherein the shaft grounding assembly comprises a brush shaft grounding assembly.

5. The apparatus as claimed in claim 4, wherein the brush shaft grounding assembly comprises a brush contacting the shaft, and wherein the insulation layer is designed within the brush.

6. The apparatus as claimed in claim 1, wherein the shaft grounding assembly comprises a braid shaft grounding assembly.

7. The apparatus as claimed in claim 6, wherein the braid shaft grounding assembly comprises a braid support and a plurality of braids contacting the shaft, and wherein the insulation layer is designed between the braid support and one of the braids.

8. The apparatus as claimed in claim 1, wherein the impedance of the first circuit is at least in an order of thousand Ohms.

9. The apparatus as claimed in claim 1, wherein the impedance of the first circuit is at least in an order of mega Ohms.

10. A shaft grounding system comprising:
a shaft grounding assembly configured to contact a shaft;
an insulation layer arranged in the shaft grounding assembly that splits the shaft grounding assembly to a first part and a second part;
a first cable connected to the first part;
a first circuit connected to the first cable that is configured to measure a signal of the first part, wherein the first circuit has an impedance such that current of the shaft travels through the second part;
a second cable connected to the second part;
a second circuit connected to the second cable that is configured to measure a signal of the second part; and
a panel connected to the first circuit and the second circuit that is configured to monitor an operation of the shaft grounding assembly based on the measured signals of the first part and the second part.

11. The system as claimed in claim 10, wherein the measured signals of the first part and the second part comprise a signal consisting of: a voltage of the first part, a voltage of the second part, a current traveling through the first part, and a current traveling through the second part.

12. The system as claimed in claim 10, wherein an alert signal is generated if the measured signal of the first part, or the measured signal of the second part, or a difference between the measured signals of the first part and the second part is not within a predetermined range.

13. The system as claimed in claim 12, wherein the panel further comprises an input device that is configured to input the predetermined range.

14. The system as claimed in claim 10, wherein the shaft grounding assembly comprises a brush shaft grounding assembly.

15. The system as claimed in claim 14, wherein the brush shaft grounding assembly comprises a brush contacting the shaft, and wherein the insulation layer is designed within the brush.

16. The system as claimed in claim 10, wherein the shaft grounding assembly comprises a braid shaft grounding assembly.

17. The system as claimed in claim 16, wherein the braid shaft grounding assembly comprises a braid support and a braid contacting the shaft, and wherein the insulation layer is designed between the braid support and the braid.

18. A method for grounding a shaft comprising:
measuring a signal of a first part of a shaft grounding assembly contacting a shaft by a first circuit, wherein the shaft grounding assembly comprises an insulation layer that splits the shaft grounding assembly to the first part and a second part, wherein the first circuit is connected to the first part via a first cable, and wherein the first circuit has an impedance such that current of the shaft travels through the second part; and
carrying the current of the shaft to ground via a second cable connected to the second part.

19. The method as claimed in claim 18, further comprising measuring a signal of the second part via a second circuit connected to the second cable.

20. The method as claimed in claim 19, further comprising generating an alert signal if the measured signal of the first part, or the measured signal of the second part, or a difference between the measured signals of the first part and the second part is not within a predetermined range.
